(19) United States
(12) Patent Application Publication
(10) Pub. No.: US 2026/0141413 A1
(43) Pub. Date: May 21, 2026

(54) STORE DETERMINATION DEVICE

(71) Applicant: NTT DOCOMO, INC., Tokyo (JP)

(72) Inventors: Akinari SAKAI, Chiyoda-ku (JP); Tetsuya YAMAGUCHI, Chiyoda-ku (JP); Yusuke NAKAMURA, Chiyoda-ku (JP)

(73) Assignee: NTT DOCOMO, INC., Tokyo (JP)

(21) Appl. No.: 18/881,135

(22) PCT Filed: May 30, 2023
(86) PCT No.: PCT/JP2023/020032

§ 371 Date: Jan. 3, 2025

(30) Foreign Application Priority Data
Aug. 31, 2022 (JP) 2022-137914

(51) Int. Cl. G06Q 30/0202

(52) U.S. Cl. CPC G06Q 30/02023

(57) ABSTRACT

An object is to determine a store that a target user is visiting. A store determination device 1, includes: a specifying unit 12 specifying a store that each user adjacent to a target user is visiting or is likely to visit; and a determination unit 13 determining a store that the target user is visiting, on the basis of the specifying of the specifying unit 12. The specifying unit 12 may set a user carrying a mobile terminal 2 adjacent to a mobile terminal 2 carried by the target user as the user adjacent to the target user. The store determination device 1 may further include a storage unit 10 storing store information relevant to the store that each user is visiting or is likely to visit, and the specifying unit 12 may perform specifying with reference to the store information stored by the storage unit 10.

### TECHNICAL FIELD

One aspect of the present disclosure relates to a store determination device determining a store that a target user is visiting.

### BACKGROUND ART

In Patent Literature 1 described below, an application server control module is disclosed in which it is possible to disclose a dynamic cluster relevant to a cluster based on persons by clustering an approach or an encounter between persons adjacent to a reference person (Paragraph 0143).

### CITATION LIST

### Patent Literature

Patent Literature 1: International Publication WO 2019/049356

### SUMMARY OF INVENTION

### Technical Problem

The application server control module discloses the dynamic cluster relevant to the cluster based on the persons, but for example, is not capable of determining a store that the reference person (a target user) is visiting. Therefore, it is desirable to determine the store that the target user is visiting.

### Solution to Problem

A store determination device according to one aspect of the present disclosure, includes: a specifying unit specifying a store that each user adjacent to a target user is visiting or is likely to visit; and a determination unit determining a store that the target user is visiting, on the basis of the specifying of the specifying unit.

In such an aspect, the store that each user adjacent to the target user is visiting or is likely to visit is specified, and the store that the target user is visiting is determined on the basis of the specifying. That is, it is possible to determine the store that the target user is visiting.

### Advantageous Effects of Invention

According to one aspect of the present disclosure, it is possible to determine the store that the target user is visiting.

### BRIEF DESCRIPTION OF DRAWINGS

FIG. 1 A diagram illustrating an example of a system configuration of a store determination system including a store determination device according to an embodiment.

FIG. 2 A diagram illustrating a table example of contact information.

FIG. 3 A diagram illustrating an example of a functional configuration of the store determination device according to the embodiment.

FIG. 4 A diagram illustrating a table example of the connection information.

FIG. 5 A diagram illustrating a table example of ground truth information.

FIG. 6 A diagram illustrating a table example of store information.

FIG. 7 A diagram illustrating Example 1 of store determination.

FIG. 8 A diagram illustrating Example 2 of the store determination.

FIG. 9 A diagram illustrating Example 3 of the store determination.

FIG. 10 A diagram illustrating Example 4 of the store determination.

FIG. 11 A diagram illustrating Example 5 of the store determination.

FIG. 12 A diagram illustrating a table example of visit determination information.

FIG. 13 A diagram illustrating a table example of visit date and time information.

FIG. 14 A diagram illustrating an example of processing executed by the store determination device according to the embodiment.

FIG. 15 A diagram illustrating an example of a hardware configuration of a computer used in the store determination device according to the embodiment.

### DESCRIPTION OF EMBODIMENTS

Hereinafter, an embodiment of the present disclosure will be described in detail with reference to the drawings. Note that in the description of the drawings, the same reference numerals will be applied to the same elements, and the repeated description will be omitted. In addition, the embodiment of the present disclosure in the following description is a specific example of the present invention, and the present invention is not limited to the embodiment unless otherwise specified to limit the present invention.

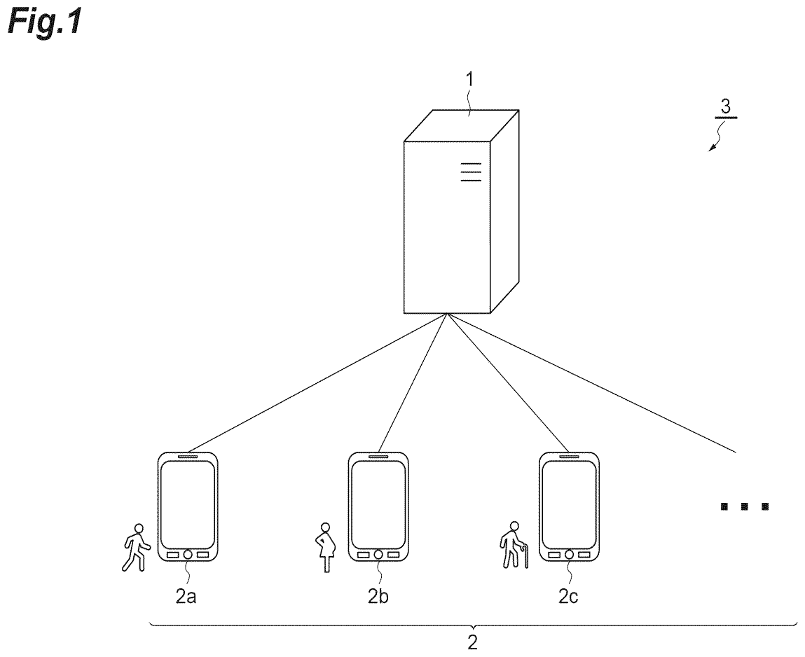

FIG. 1 is a diagram illustrating an example of a system configuration of a store determination system 3 including a store determination device 1 according to an embodiment. As illustrated in FIG. 1, the store determination system 3 is configured by including a store determination device 1 and one or more mobile terminals 2 (a mobile terminal 2a, a mobile terminal 2b, a mobile terminal 2c, . . . will be suitably referred to as a mobile terminal 2 in an all-inclusive term). The store determination device 1 and each of the mobile terminals 2 are connected to each other via a network such as a mobile communication network such that communication is available, and are capable of transmitting and receiving information to and from each other.

The store determination device 1 is a computer device (a server) determining a store that a target user who is a user to be a target is visiting. The user is a person using a function or a service provided by the store determination device 1. Each user carries the mobile terminal 2. The target user is a user for whom the store determination device 1 determines which store the user is visiting. A user whose visit with respect to a store is not known is assumed as the target user. The store, for example, is a building for selling products, a building or an area for providing services, or the like. The details of the store determination device 1 will be described below.

The mobile terminal 2 is a mobile communication terminal performing mobile communication or a computer device such as a laptop computer. In this embodiment, a smart phone is assumed as the mobile terminal 2, but the mobile terminal is not limited thereto. The mobile terminal 2 is carried by each user as described above.

The mobile terminal 2 is capable of performing near-field wireless communication by Bluetooth (Registered Trademark) low energy (BLE), which is a part of Bluetooth (Registered Trademark), or the like. In a case where the mobile terminals 2 fall within a certain distance range, the mobile terminals 2 automatically exchange identification information of the own terminal with each other by the near-field wireless communication without the operation of the user or the like. Falling within the certain distance range is also referred to as being in contact with each other or adjacent to each other. It is indicated that each of the mobile terminals 2 is in contact with the opponent mobile terminal 2 or the user of the mobile terminal 2 is in contact with the user of the opponent mobile terminal 2 by exchanging the identification information of the own terminal. In this embodiment, a user ID for identifying the user carrying the mobile terminal 2 is used as the identification information of the own terminal (the mobile terminal 2), but the identification information is not limited thereto.

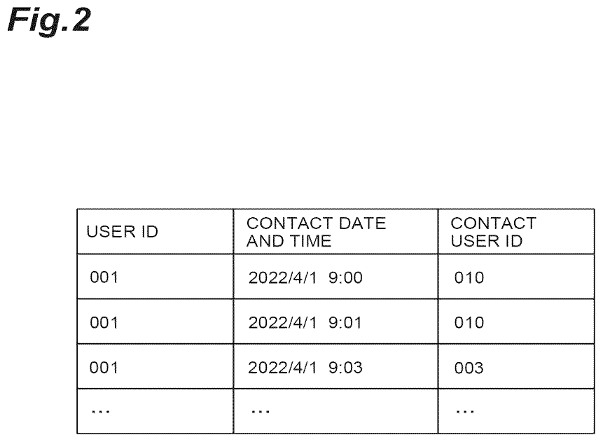

The mobile terminal 2 (assumed as the mobile terminal 2a) generates contact information relevant to contact between users, on the basis of a user ID (a contact user ID) of the user carrying the mobile terminal 2b, which is received from the mobile terminal 2b when the mobile terminal 2 is in contact with another mobile terminal 2 (assumed as the mobile terminal 2b). FIG. 2 is a diagram illustrating a table example of the contact information. In the contact information illustrated in FIG. 2, a user ID of the user carrying the mobile terminal 2 (for example, the mobile terminal 2a) that is the own terminal, a contact date and time that is a date and time when the mobile terminal 2 is in contact with another mobile terminal 2 (for example, the mobile terminal 2b or the like), and a contact user ID that is a user ID of a user carrying another mobile terminal 2 are associated with each other. The mobile terminal 2 transmits the contact information to the store determination device 1 periodically (for example, every minute). The contact information may be referred to as a BLE log.

In addition, the mobile terminal 2 may have functions, sensors, or the like provided in a general smart phone, such as an electrical wave positioning function, a positioning function of a global positioning system (GPS), a payment function, or an acceleration sensor, and may transmit information or the like acquired by such functions or sensors to the store determination device 1.

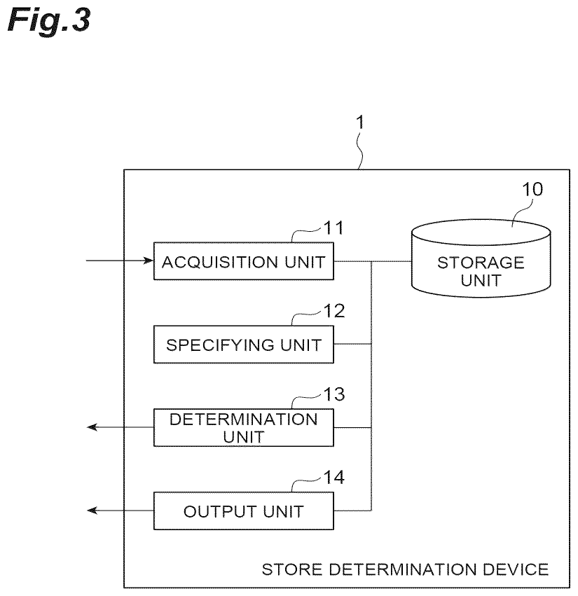

FIG. 3 is a diagram illustrating an example of a functional configuration of the store determination device 1 according to the embodiment. As illustrated in FIG. 3, the store determination device 1 is configured by including a storage unit 10 (a storage unit), an acquisition unit 11, a specifying unit 12 (a specifying unit), a determination unit 13 (a determination unit), and an output unit 14.

Each function block of the store determination device 1 is assumed to function in the store determination device 1, but is not limited thereto. For example, a part of the function blocks of the store determination device 1 may function in a computer device that is different from the store determination device 1 and is connected to the store determination device 1 via a network while suitably transmitting and receiving information with respect to the store determination device 1. In addition, a part of the function blocks of the store determination device 1 may not be provided, a plurality of function blocks may be integrated into one function block, or one function block may be decomposed into a plurality of function blocks.

Hereinafter, each function of the store determination device 1 illustrated in FIG. 3 will be described.

The storage unit 10 stores any information used for computation or the like in the store determination device 1, a result of the computation in the store determination device 1, and the like. The information stored by the storage unit 10 may be suitably referred to by each function of the store determination device 1.

The information stored by the storage unit 10 may be information that is acquired by the acquisition unit 11 and stored, may be information that is generated by the acquisition unit 11 or the specifying unit 12 and stored, may be information that is input by an administrator or the like of the store determination device 1 and stored, or may be information stored in advance.

The storage unit 10 may store the contact information (described above).

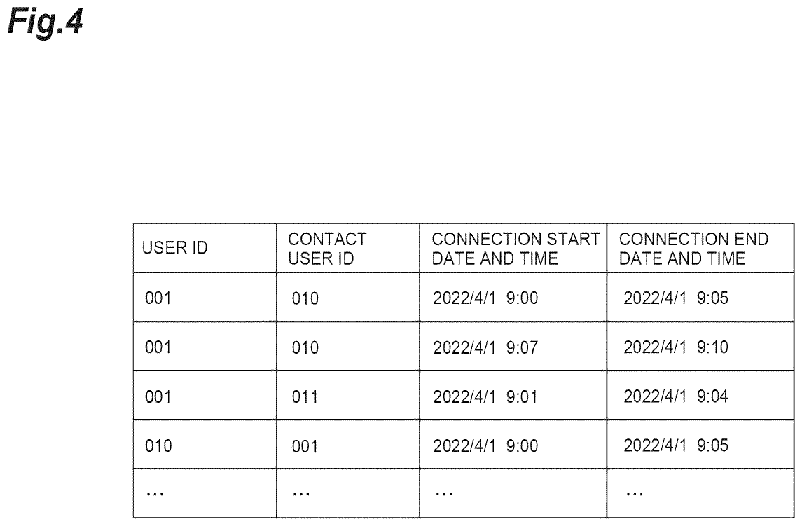

The storage unit 10 may store connection information relevant to connection between users, which is generated on the basis of the contact information. The connection indicates continuous contact. FIG. 4 is a diagram illustrating a table example of the connection information. In the connection information illustrated in FIG. 4, the user ID of the user carrying the mobile terminal 2, the contact user ID that is the user ID of the user carrying the another mobile terminal 2 in contact with the mobile terminal 2, a connection start date and time that is a date and time when the connection that is the continuous contact is started, and a connection end date and time that is a date and time when the connection is ended are associated with each other. The connection information may be generated by the acquisition unit 11, on the basis of the contact information, or may be generated by the mobile terminal 2, on the basis of the contact information, and may be transmitted to the store determination device 1. For the generation of the connection information, for example, in a case where there is continuous contact for 5 minutes every minute in the contact information, the continuous contact is considered as 5-minute connection, and the start and the end of the corresponding contact date and time may be generated as the connection start date and time and the connection end date and time in the connection information, respectively.

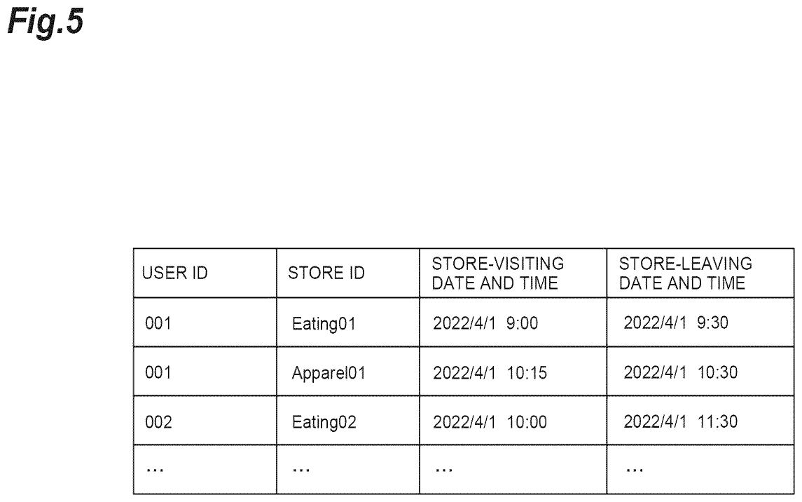

The storage unit 10 stores ground truth information relevant to the visit store of the user. FIG. 5 is a diagram illustrating a table example of the ground truth information. In the ground truth information illustrated in FIG. 5, a user ID, a store ID for identifying a store that a user identified by the user ID visits, a store-visiting date and time that is a date and time when the user visits the store, and a store-leaving date and time that is a date and time when the user leaves the store are associated with each other. The ground truth information is information (in which a visit with respect to a store is determined) generated by a method of the related art using an electrical wave positioning result, (the history of) position information by a GPS or the like, payment (history) information by a credit card, various types of electronic money, or the like, information of contact via near-field wireless communication, or the like. In this embodiment, the user of the ground truth information, that is, a user whose visit with respect to a store is determined by the method of the related art (with a high accuracy) will be referred to as a ground-truth user. Note that the target user may be a user other than the ground-truth user. As the target user set as a visit store determination target by the store determination device 1, a user for whom the position information, the payment information, and the like as described above are not capable of being acquired, and (only) the contact determination by BLE can be performed, rather than the ground-truth user, is assumed.

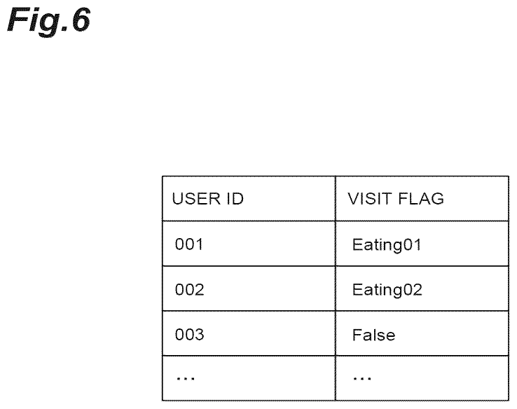

The storage unit 10 stores store information relevant to a store that each user is visiting or is likely to visit. FIG. 6 is a diagram illustrating a table example of the store information. In the store information illustrated in FIG. 6, a user ID and a visit flag that is a store ID of a store that a user identified by the user ID is visiting or is likely to visit at a certain time point are associated with each other. As described above, the store information is information at a certain time point. The storage unit 10 may store the store information at a plurality of time points (for example, every minute). The store information may be generated by the acquisition unit 11 or the specifying unit 12.

The acquisition unit 11 acquires information from another device via the network, and stores the acquired information by the storage unit 10. The acquisition unit 11 may process the acquired information while suitably referring to various types of information stored by the storage unit 10, and then, may store the information by the storage unit 10. For example, the acquisition unit 11 may acquire the contact information from each of the mobile terminals 2, may generate the connection information, on the basis of the acquired contact information, and may store the generated connection information by the storage unit 10. In addition, the acquisition unit 11 may acquire the contact information, the connection information, the ground truth information, the store information, or the like, and may store the information by the storage unit 10.

The specifying unit 12 specifies the store that each user adjacent to the target user is visiting or is likely to visit. The specifying unit 12 may store a specifying result by the storage unit 10, or may output the specifying result to the determination unit 13.

The specifying unit 12 may set the user carrying the mobile terminal 2 adjacent to (in contact with, connected to) the mobile terminal 2 carried by the target user, as the user adjacent to the target user. That is, the specifying unit 12 may specify the store that each user carrying the mobile terminal 2 (for example, the mobile terminal 2b, the mobile terminal 2c, or the like) adjacent to the mobile terminal 2 (for example, the mobile terminal 2a) carried by the target user is visiting or is likely to visit.

The specifying unit 12 may perform specifying with reference to the store information stored by the storage unit 10. That is, the specifying unit 12 may specify the store that each user adjacent to the target user is visiting or is likely to visit, with reference to the store information stored by the storage unit 10. More specifically, the specifying unit 12 acquires a user ID of each user adjacent to the target user, and specifies a store indicated by a visit flag ID associated with the user ID in the store information, as a store that the user identified by the user ID is visiting or is likely to visit.

The specifying unit 12 may generate the store information at a predetermined time point (for example, the current time point, n minutes before the current time point (n is an integer), a time point designated by the administrator or the like of the store determination device 1, or the like) periodically (for example, every minute), and may store the store information by the storage unit 10. Specifically, in a case where, for each user, it is determined that the user is visiting the store at the predetermined time point, with reference to the ground truth information stored by the storage unit 10, the specifying unit 12 registers the store ID of the store as the visit flag of the store information. Further, in a case where, for each user, it is determined that the user is likely to visit the store at the predetermined time point, with reference to visit date and time information (described below) stored by the storage unit 10, the specifying unit 12 may register the store ID of the store as the visit flag of the store information. The specifying unit 12, for a user who is not visiting or is not likely to visit the store at the predetermined time point, may register “False” indicating that effect as the visit flag. The specifying unit 12 (or the store determination device 1) may set a user with a visit flag of “False” in the store information, as the target user.

The specifying unit 12 may perform specifying by associating an adjacent user who is each user adjacent to the target user with a visit store that is a store that the adjacent user is visiting or is likely to visit. For example, the specifying unit 12 extracts the adjacent user (the contact user ID) adjacent to the target user at the predetermined time point, with reference to the connection information stored by the storage unit 10, and extracts the visit store of the adjacent user (the store ID indicated by the visit flag), with reference to the store information stored by the storage unit 10. Then, the specifying unit 12 may store specifying information in which the extracted adjacent user (contact user ID) and the extracted visit store (store ID) are associated with each other by the storage unit 10, or may output the specifying information to the determination unit 13.

The determination unit 13 determines the store that the target user is visiting, on the basis of the specifying of the specifying unit 12. More specifically, The determination unit 13 determines the store that the target user is visiting, on the basis of the specifying result or the specifying information stored by the storage unit 10, or the specifying result or the specifying information input from the specifying unit 12. The determination unit 13 may output a determination result (for example, display the determination result or transmit the determination result to another device via the network), may store the determination result by the storage unit 10, or may output the determination result to the output unit 14. For example, the determination result is information indicating one or more stores (store IDs) determined to be visited by the target user at the predetermined time point. The determination unit 13 may update the visit flag of the store information stored by the storage unit 10, on the basis of the determination result.

Specific determination examples of the determination unit 13 will be described in Examples 1 to 5 described below. Note that the determination unit 13 performs determination by suitably referring to the contact information, the connection information, the ground truth information, the store information, or the like, which is stored by the storage unit 10.

### Example 1

The determination unit 13 may determine the store that the target user is visiting, on the basis of the number of adjacent users associated with each visit store. More specifically, the determination unit 13, for each visit store included in the specifying information, computes the number of adjacent users associated with the visit store, and determines the store that the target user is visiting, on the basis of the computed number of adjacent users of each visit store. For example, the determination unit 13 determines a visit store with the largest number of adjacent users, as the store that the target user is visiting. In addition, for example, the determination unit 13 may determine a first candidate store, a second candidate store, a third candidate store, . . . that the target user is visiting, in order of the visit store with a larger number of adjacent users.

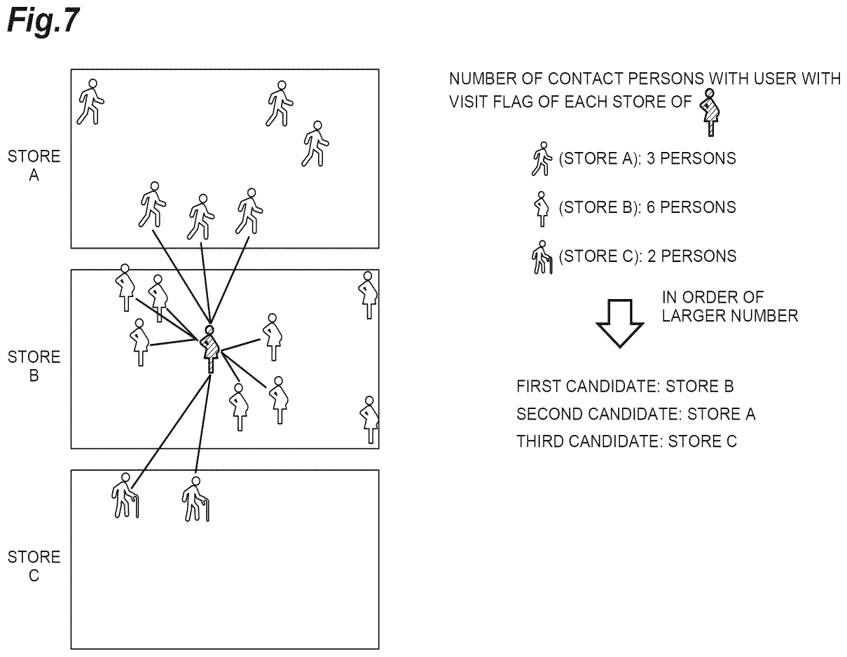

FIG. 7 is a diagram illustrating Example 1 of the store determination. In FIG. 7 (and the subsequent drawings), the target user is in the vicinity of the center of a store B, and is indicated by a hatched human-shaped icon. A user other than the target user is indicated by an unhatched human-shaped icon. The adjacent user is a user to whom a solid line extends from the target user. The visit store is a store A, a store B, and a store C.

In FIG. 7, there are three adjacent users in the store A, there are six adjacent users in the store B, and there are two adjacent users in the store C (here, “there are” indicates visiting or being likely to visit, and since in the store information, the visit flag of the user indicates the store, a user in a certain store is suitably represented as a user with the visit flag of the store). In this case, the determination unit 13 determines the first candidate store that the target user is visiting as the store B, the second candidate store that the target user is visiting as the store A, and the third candidate store that the target user is visiting as the store C, in order of the visit store with a larger number of adjacent users.

### Example 2

The determination unit 13 may determine the store that the target user is visiting, on the basis of the number of adjacent users associated with the visit store and the number of users who are visiting or are likely to visit the visit store (computed with reference to the store information), for each visit store. The determination unit 13 may determine the store that the target user is visiting, on the basis of a ratio between the number of adjacent users associated with the visit store and the number of users who are visiting or are likely to visit the visit store, for each visit store. For example, the determination unit 13 determines a visit store with the largest value obtained by dividing the number of adjacent users of the former by the number of users of the latter, which is the ratio, as the store that the target user is visiting. In addition, for example, the determination unit 13 may determine the first candidate store, the second candidate store, the third candidate store, . . . that the target user is visiting, in order of the visit store with a larger ratio.

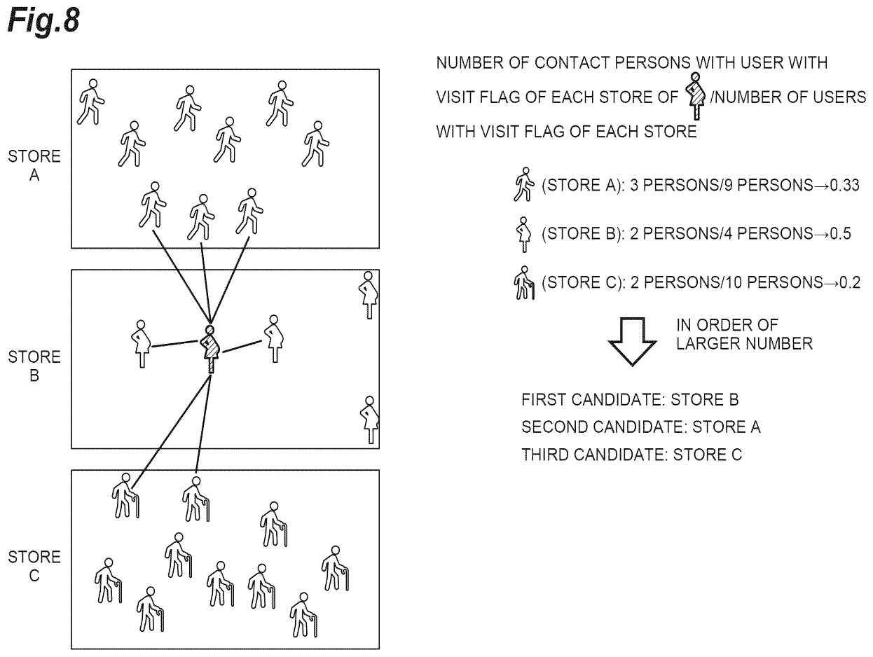

FIG. 8 is a diagram illustrating Example 2 of the store determination. In FIG. 8, there are three adjacent users in the store A, there are two adjacent users in the store B, and there are two adjacent users in the store C. In addition, the number of users in the store A is 9, the number of users in the store B is 4, and the number of users in the store C is 10. Therefore, the ratio described above is 3/9=0.33 in the store A, is 2/4=0.5 in the store B, and is 2/10=0.2 in the store C. In this case, the determination unit 13 determines the first candidate store that the target user is visiting as the store B, the second candidate store that the target user is visiting as the store A, and the third candidate store that the target user is visiting as the store C, in order of the visit store with a larger ratio.

### Example 3

The determination unit 13 may determine the store that the target user is visiting, on the basis of the number of users who are visiting or are likely to visit each visit store associated with one or more adjacent users (computed with reference to the store information). For example, the determination unit 13 determines the visit store with the largest number of users who are visiting or are likely to visit each visit store associated with one or more adjacent users, as the store that the target user is visiting. In addition, for example, the determination unit 13 may determine the first candidate store, the second candidate store, the third candidate store, . . . that the target user is visiting, in order of the visit store with a larger number of users who are visiting or are likely to visit each visit store associated with one or more adjacent users.

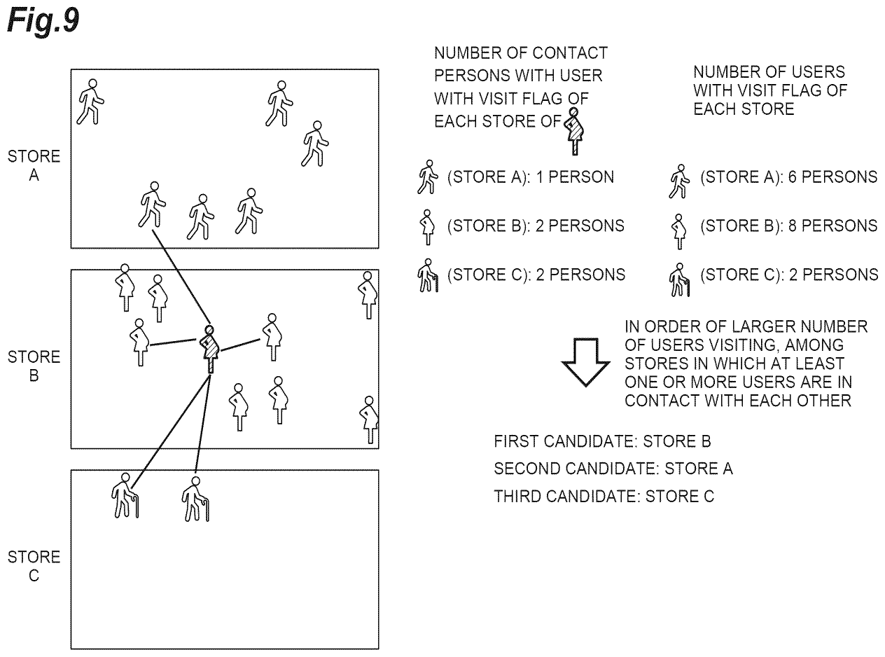

FIG. 9 is a diagram illustrating Example 3 of the store determination. In FIG. 9, there is one adjacent user in the store A, there are two adjacent users in the store B, and there are two adjacent users in the store C. Therefore, the visit store associated with one or more adjacent users is the store A, the store B, and the store C. The number of users in the store A is 6, the number of users in the store B is 8, and the number of users in the store C is 2. In this case, the determination unit 13 determines the first candidate store that the target user is visiting as the store B, the second candidate store that the target user is visiting as the store A, and the third candidate store that the target user is visiting as the store C, in order of the visit store with a larger number of users, among the store A, the store B, and the store C.

### Example 4

The determination unit 13 may determine the store that the target user is visiting, on the basis of the number of adjacent users associated with the visit store, and the number of adjacencies of the adjacent user to a user who is adjacent to the adjacent user and is visiting or is likely to visit the visit store (computed with reference to the connection information and the store information), for each visit store. For example, the determination unit 13 determines a visit store with the largest sum of the number of adjacent users of the former and the number of adjacencies of the latter, as the store that the target user is visiting. In addition, for example, the determination unit 13 may determine the first candidate store, the second candidate store, the third candidate store, . . . that the target user is visiting, in order of the visit store with a larger sum of the number of adjacent users of the former and the number of adjacencies of the latter (in a case where the ratio is the same, the number of adjacent users of the former is prioritized).

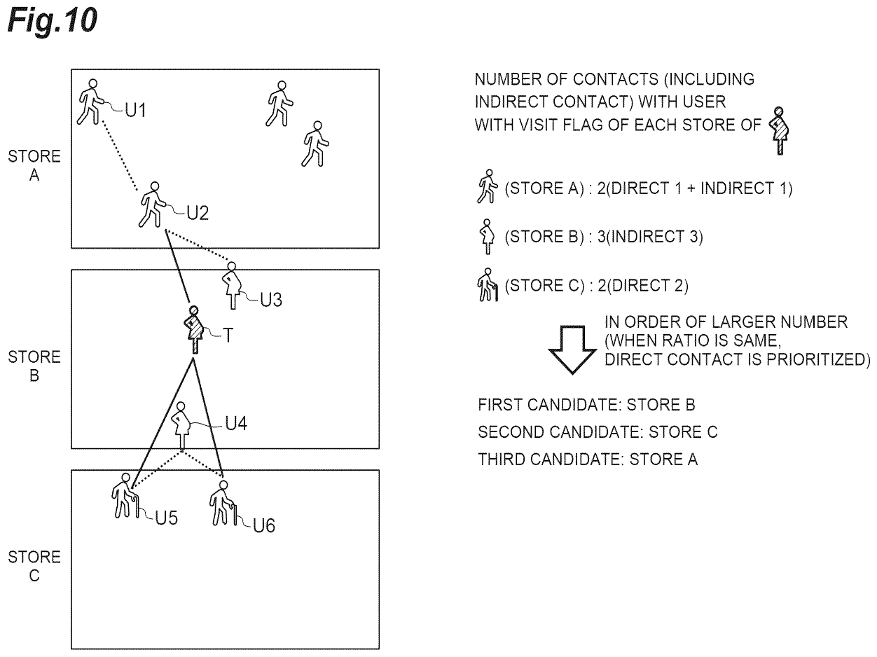

FIG. 10 is a diagram illustrating Example 4 of the store determination. In FIG. 10 (and the subsequent drawings), the user adjacent to the adjacent user is a user to whom a broken line extends from the adjacent user.

In FIG. 10, there is one adjacent user (a user U2) (the number of direct contacts) in the store A, there are 0 adjacent users in the store B, and there are two adjacent users (a user U5 and a user U6) in the store C. In addition, the number of adjacencies (the number of indirect contacts) of the store A is 1 (contact from the user U2 to a user U1), the number of adjacencies of the store B is 3 (contact from the user U2 to a user U3, contact from the user U5 to a user U4, and contact from the user U6 to the user U4), and the number of adjacencies of the store C is 0. Therefore, as the sum described above, the store A is 1 (direct)+1 (indirect)=2, the store B is 0 (direct)+3 (indirect)=3, and the store C is 2 (direct)+0 (indirect)=2. In this case, the determination unit 13 determines the first candidate store that a target user T is visiting as the store B, the second candidate store that the target user T is visiting as the store C, and the third candidate store that the target user T is visiting as the store A, in order of the visit store with a larger sum (in a case where the ratio is the same, the number of “Direct” is prioritized). Here, since the values of the store A and the store C are the same as 2, but the number of “Direct” is 1 in the store A and 2 in the store C, the store C is prioritized, and the second candidate store is determined as the store C, and the third candidate store is determined as the store A.

### Example 5

The determination unit 13 may determine the store that the target user is visiting, on the basis of a number weight by each of the number of adjacent users associated with the visit store, and the number of adjacencies of the adjacent user to the user who is adjacent to the adjacent user and is visiting or is likely to visit the visit store (computed with reference to the connection information and the store information), for each visit store. For example, the determination unit 13 determines a visit store with the largest sum of the weighted numbers, as the store that the target user is visiting. In addition, for example, the determination unit 13 may determine the first candidate store, the second candidate store, the third candidate store, . . . that the target user is visiting, in order of the visit store with a larger sum of the weighted numbers.

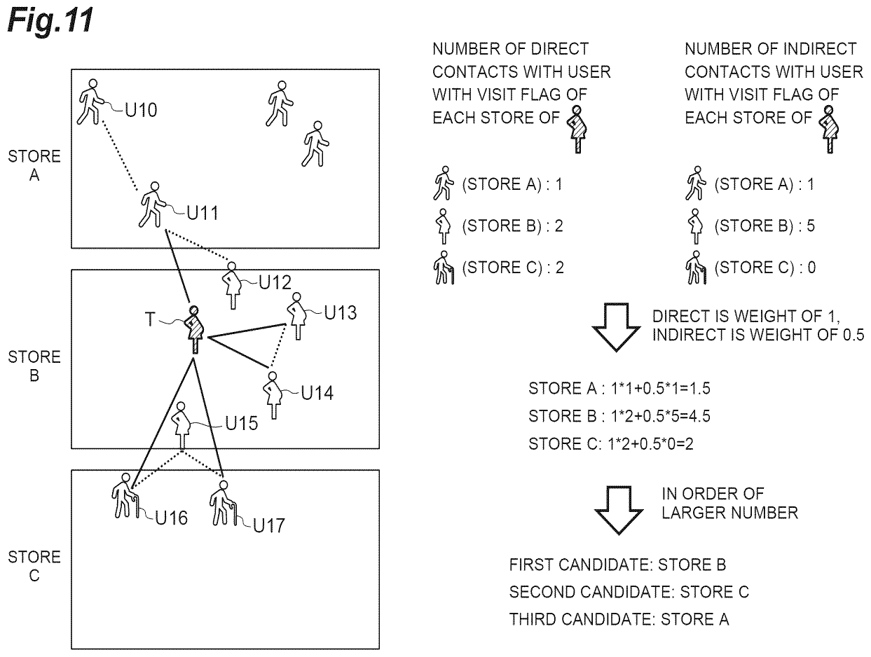

FIG. 11 is a diagram illustrating Example 5 of the store determination. In FIG. 11, there are one adjacent user (a user U11) (the number of direct contacts) in the store A, there are two adjacent users (a user U13 and a user U14) in the store B, and there are two adjacent users (a user U16 and a user U17) in the store C. In addition, the number of adjacencies (the number of indirect contacts) in the store A is 1 (contact from the user U11 to a user U10), the number of adjacencies in the store B is 5 (contact from the user U11 to a user U12, contact from the user U14 to the user U13, contact from the user U13 to the user U14, contact from the user U16 to a user U15, and contact from the user U17 to the user U15), and the number of adjacencies in the store C is 0. Here, in a case where the weight of the number of direct contacts is set as 1, and the weight of the number of indirect contacts is set as 0.5, as the sum described above, the store A is 1*1+0.5*1=1.5, the store B is 1*2+0.5*5=4.5, and the store C is 1*2+0.5*0=2. In this case, the determination unit 13 determines the first candidate store that the target user T is visiting as the store B, the second candidate store that the target user T is visiting as the store C, and the third candidate store that the target user T is visiting as the store A, in order of the visit store with a larger sum. Note that in a case where the ratio is the same, as with Example 4, the number of direct contacts may be prioritized.

The output unit 14 outputs the determination result of the determination unit 13, or performs output based on the result. The output, for example, may be displayed on a display that is one of output devices 1006 described below, or may be transmitted to another device via a communication device 1004 described below. For example, the output unit 14 may display one or more stores indicating the determination result input from the determination unit 13, as the store that the target user is visiting.

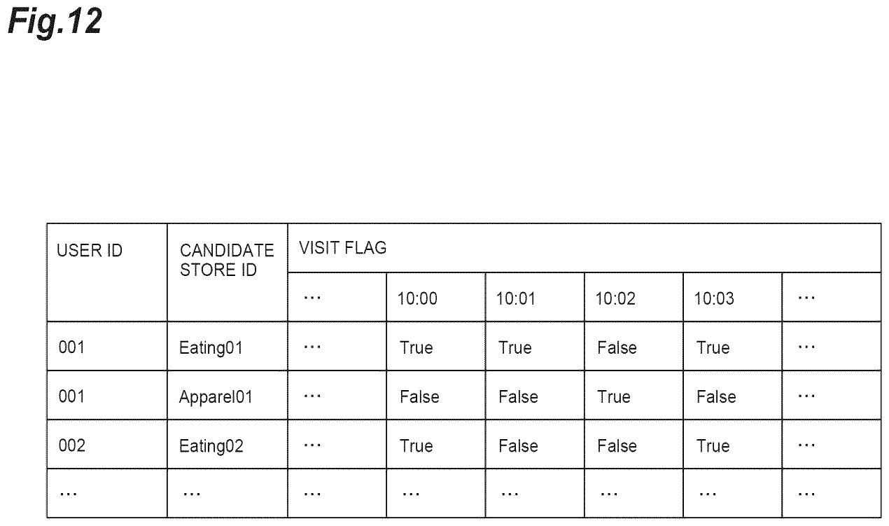

The output unit 14 may generate visit determination information in which the visit determination of each user (or target user) with respect to the store is organized, on the basis of the determination result of the determination unit 13. More specifically, the output unit 14 collects the determination result of the determination unit 13 at the predetermined time point for a predetermined period, and organizes (compiles) the information to generate the visit determination information. FIG. 12 is a diagram illustrating a table example of the visit determination information. In the visit determination information illustrated in FIG. 12, a user ID, a candidate store ID that is a store ID of a visit candidate store of a user identified by the user ID, and a visit flag for each date and time (dates are omitted in FIG. 12) (“True” in a case where it is determined that the user is visiting the store, and “False” in a case where it is not determined that the user is visiting the store) are associated with each other. The output unit 14 may output the generated visit determination information.

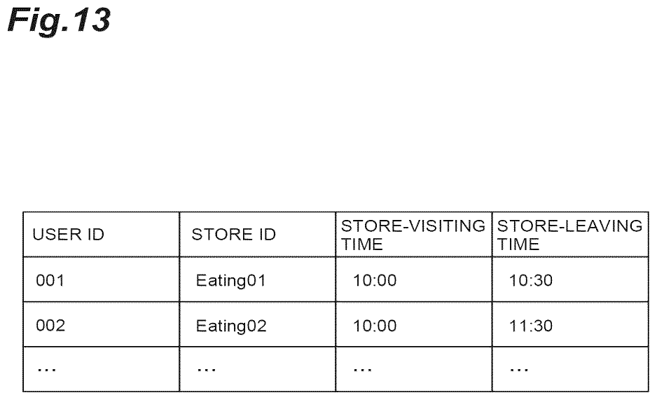

The output unit 14 may further organize the generated visit determination information to generate the visit date and time information in which a visit date and time of each user (or target user) with respect to the store is organized. More specifically, the output unit 14 organizes (compiles) the information by determining that in a case where there is visit determination for Y minutes or longer in continuous X minutes, the user is visiting for X minutes, in the visit determination information, and generates the visit date and time information. FIG. 13 is a diagram illustrating a table example of the visit date and time information. In the visit date and time information illustrated in FIG. 13, a user ID, a store ID of a store that a user identified by the user ID is likely to visit, a store-visiting time that is a time when the user is likely to visit the store (dates are omitted in FIG. 13), and a store-leaving time that is a time when the user is likely to leave the store (dates are omitted in FIG. 13) are associated with each other. The output unit 14 may output the generated visit date and time information.

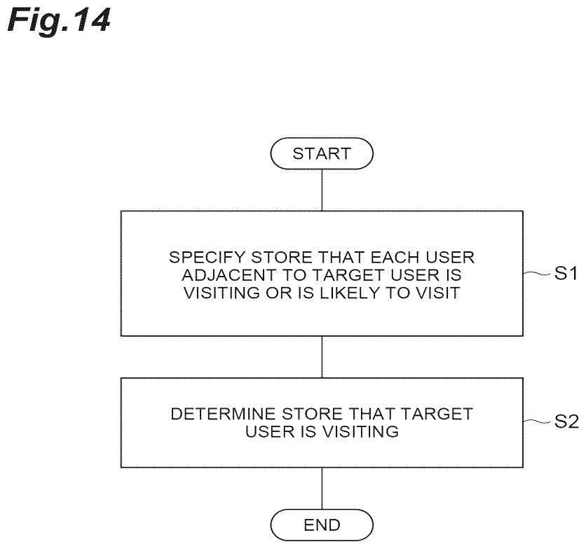

Subsequently, an example of processing (a store determination method) executed by the store determination device 1 will be described with reference to FIG. 14. FIG. 14 is a flowchart illustrating an example of the processing executed by the store determination device 1.

First, the specifying unit 12 specifies the store that each user adjacent to the target user is visiting or is likely to visit (step S1, a specifying step). Next, the determination unit 13 determines the store that the target user is visiting, on the basis of the specifying of the specifying unit 12 in S1 (step S2, a determining step).

Subsequently, the function effect of the store determination device 1 according to the embodiment will be described.

According to the store determination device 1, the store determination device 1 includes the specifying unit 12 specifying the store that each user adjacent to the target user is visiting or is likely to visit, and the determination unit 13 determining the store that the target user is visiting, on the basis of the specifying of the specifying unit 12. According to such a configuration, the store that each user adjacent to the target user is visiting or is likely to visit is specified, and the store that the target user is visiting is determined on the basis of the specifying. That is, it is possible to determine the store that the target user is visiting.

In addition, according to the store determination device 1, the specifying unit 12 may set the user carrying the mobile terminal 2 adjacent to the mobile terminal 2 carried by the target user as the user adjacent to the target user. According to such a configuration, since the specifying unit 12, for example, is capable of determining the user adjacent to the target user using near-field wireless communication by BLE or the like, it is possible to more reliably determine the user adjacent to the target user.

In addition, according to the store determination device 1, the store determination device 1 may further include the storage unit 10 storing the store information relevant to the store that each user is visiting or is likely to visit, and the specifying unit 12 may perform specifying with reference to the store information stored by the storage unit 10. According to such a configuration, the specifying unit 12 is capable of more reliably performing specifying with reference to the store information.

In addition, according to the store determination device 1, the specifying unit 12 may perform specifying by associating the adjacent user who is each user adjacent to the target user with the visit store that is the store that the adjacent user is visiting or is likely to visit. According to such a configuration, the specifying unit 12 is capable of more reliably performing specifying by associating the adjacent user with the visit store.

In addition, according to the store determination device 1, the determination unit 13 may determine the store that the target user is visiting, on the basis of the number of adjacent users associated with each visit store. According to such a configuration, by adding the number of adjacent users associated with the visit store, it is possible to more accurately determine the store that the target user is visiting. Such a configuration is based on an idea that being adjacent to (in contact with) a user with a visit flag of a popular (frequented) store indicates visiting the popular store. According to such a configuration, for example, it is possible to simply determine the store that the target user is visiting, in order of the number of contact persons. Such a configuration can be applied in a place where popularity is biased to a specific store.

In addition, according to the store determination device 1, the determination unit 13 may determine the store that the target user is visiting, on the basis of the number of adjacent users associated with the visit store and the number of users who are visiting or are likely to visit the visit store, for each visit store. According to such a configuration, by adding both of the number of adjacent users associated with the visit store and the number of users who are visiting or are likely to visit the visit store, it is possible to more accurately determine the store that the target user is visiting. Such a configuration can be utilized in a general store.

In addition, according to the store determination device 1, the determination unit 13 may determine the store that the target user is visiting, on the basis of the ratio between the number of adjacent users associated with the visit store and the number of users who are visiting or are likely to visit the visit store, for each visit store. According to such a configuration, by adding the ratio between the number of adjacent users associated with the visit store and the number of users who are visiting or are likely to visit the visit store, it is possible to more accurately determine the store that the target user is visiting. Such a configuration can be utilized in a general store.

In addition, according to the store determination device 1, the determination unit 13 may determine the store that the target user is visiting, on the basis of the number of users who are visiting or are likely to visit each visit store associated with one or more adjacent users. According to such a configuration, by adding the number of users who are visiting or are likely to visit each visit store associated with one or more adjacent users, it is possible to more accurately determine the store that the target user is visiting. Such a configuration is based on an idea that even in a case where the number of adjacencies (the number of contacts) itself is small, being close to a popular (frequented) store indicates visiting the popular store. According to such a configuration, for example, it is possible to determine the store that the target user is visiting among at least one or more adjacent (contact) stores, in order of a larger number of persons visiting. Such a configuration can be applied in a place where popularity is biased to a specific store, and a place where the number of contacts in a store is small due to the spaciousness of the store.

In addition, according to the store determination device 1, the determination unit 13 may determine the store that the target user is visiting, on the basis of the number of adjacent users associated with the visit store, and the number of adjacencies of the adjacent user to the user who is adjacent to the adjacent user and is visiting or is likely to visit the visit store, for each visit store. According to such a configuration, by adding the number of adjacent users associated with the visit store, and the number of adjacencies of the adjacent user to the user who is adjacent to the adjacent user and is visiting or is likely to visit the visit store, it is possible to more accurately determine the store that the target user is visiting. Such a configuration is based on an idea that even in a case where the number of adjacencies (the number of contacts) is small due to the unpopularity of the store, the spaciousness of the store, or the like, there is indirect contact with more users in the store. According to such a configuration, for example, the number of indirect adjacencies (contacts) can be counted, and the store that the target user is visiting can be determined in order of a larger number (in a case where the ratio is the same, direct contact is prioritized). Such a configuration can be applied in a place such as an unpopular store or a spacious store.

In addition, according to the store determination device 1, the determination unit 13 may determine the store that the target user is visiting, on the basis of the number weighted by each of the number of adjacent users associated with the visit store, and the number of adjacencies of the adjacent user to the user who is adjacent to the adjacent user and is visiting or is likely to visit the visit store, for each visit store. According to such a configuration, by adding the number weighted by each of the number of adjacent users associated with the visit store, and the number of adjacencies of the adjacent user to the user who is adjacent to the adjacent user and is visiting or is likely to visit the visit store, it is possible to more accurately determine the store that the target user is visiting. Such a configuration is in consideration of the number of direct contact persons (or the number of direct contacts) and the number of indirect contact persons (or the number of indirect contacts). Such a configuration can be applied in a place such as an unpopular store or a spacious store.

According to the store determination device 1, it is possible to divide store-visiting determination between the adjacent stores. In general, in order to measure the effect of measures and advertisements relevant to a commercial facility and analyze the users, it is preferable that which store is visited by a user unit can be accurately determined. As a method for determining a store visit, the use of the position information or the utilization of a payment history is considered, but it is difficult to acquire the position information or the information of the payment history of all the users.

Since it is general that a plurality of adjacent stores are placed in rows in the actual stores, there is a problem that in a case where the division between the adjacent stores is not considered, the possibility of erroneous determination is high.

Here, contact information (BLE) between users by Bluetooth (Registered Trademark) can be more easily acquired. The store determination device 1 is capable of accurately dividing and determining a specific visit store from a plurality of adjacent stores on the basis of a BLE log, by targeting at a user whose visit is difficult to be determined by a method of the related art using electrical wave positioning, GPS, payment information, or the like. The store determination device 1 is capable of estimating which store the user is highly likely to visit, on the basis of a BLE log of a user (a ground-truth user) visiting a specific store. According to the store determination device 1, it is possible to prevent erroneous determination even in the case of the adjacent stores.

The store determination device 1 of the present disclosure may have the following configurations.
[1] A store determination device, including:
a specifying unit specifying a store that each user adjacent to a target user is visiting or is likely to visit; and
a determination unit determining a store that the target user is visiting, on the basis of the specifying of the specifying unit.
[2] The store determination device according to [1],
in which the specifying unit sets a user carrying a mobile terminal adjacent to a mobile terminal carried by the target user as the user adjacent to the target user.
[3] The store determination device according to [1] or [2], further including
a storage unit storing store information relevant to the store that each user is visiting or is likely to visit,
in which the specifying unit performs specifying with reference to the store information stored by the storage unit.
[4] The store determination device according to any one of [1] to [3],
in which the specifying unit performs specifying by associating an adjacent user who is each user adjacent to the target user with a visit store that is a store that the adjacent user is visiting or is likely to visit.
[5] The store determination device according to [4],
in which the determination unit determines the store that the target user is visiting, on the basis of the number of adjacent users associated with each visit store.
[6] The store determination device according to [4],
in which the determination unit determines the store that the target user is visiting, on the basis of the number of adjacent users associated with the visit store and the number of users who are visiting or are likely to visit the visit store, for each visit store.
[7] The store determination device according to [4] or [6],
in which the determination unit determines the store that the target user is visiting, on the basis of a ratio between the number of adjacent users associated with the visit store and the number of users who are visiting or are likely to visit the visit store, for each visit store.
[8] The store determination device according to [4],
in which the determination unit determines the store that the target user is visiting, on the basis of the number of users who are visiting or are likely to visit each visit store associated with one or more adjacent users.
[9] The store determination device according to [4],
in which the determination unit, on the basis of
   the number of adjacent users associated with the visit store, and
   the number of adjacencies of the adjacent user to a user who is adjacent to the adjacent user and is visiting or is likely to visit the visit store, for each visit store,
determines the store that the target user is visiting.
[10] The store determination device according to [4] or [9],
in which the determination unit, on the basis of a number weighted by each of
   the number of adjacent users associated with the visit store, and
   the number of adjacencies of the adjacent user to a user who is adjacent to the adjacent user and is visiting or is likely to visit the visit store, for each visit store,
determines the store that the target user is visiting.

Note that a block diagram used for the description of the above embodiment illustrates the blocks of function units. Such function blocks (configuration units) are attained by any combination of at least one of hardware and software. In addition, a method for attaining each of the function blocks is not particularly limited. That is, each of the function blocks may be attained by using one physically or logically coupled device, or may be attained by using a plurality of devices obtained by directly or indirectly (for example, in a wired or wireless manner) connecting two or more devices physically or logically separated from each other. The function block may be attained by combining software with the one device or the plurality of devices.

The function includes determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating (mapping), assigning, and the like, but is not limited thereto. For example, the function block (the configuration unit) performing the transmitting is referred to as a transmitting unit or a transmitter. In either case, as described above, a method for attaining the function block is not particularly limited.

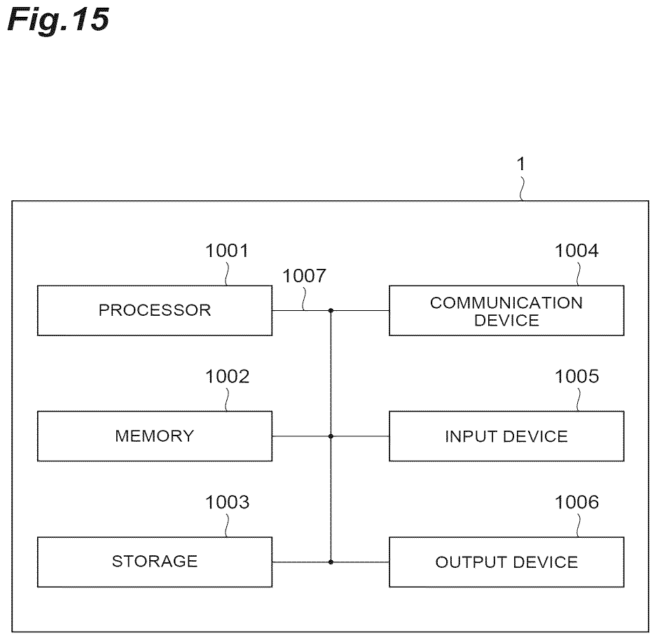

For example, the store determination device 1 or the like in one embodiment of the present disclosure may function as a computer performing the processing of the store determination method of the present disclosure. FIG. 15 is a diagram illustrating an example of a hardware configuration of the store determination device 1 according to one embodiment of the present disclosure. The store determination device 1 described above may be physically configured as a computer device including a processor 1001, a memory 1002, a storage 1003, a communication device 1004, an input device 1005, an output device 1006, a bus 1007, and the like.

Note that in the following description, the word “device” can be replaced with a circuit, a unit, or the like. The hardware configuration of the store determination device 1 may be configured to include one or a plurality of devices illustrated in the drawings, or may be configured to exclude some devices.

Each of the functions in the store determination device 1 is attained by reading predetermined software (program) on the hardware such as the processor 1001 and the memory 1002 such that the processor 1001 performs arithmetic, and controlling the communication of the communication device 1004 or controlling at least one of the reading and the writing of data in the memory 1002 and the storage 1003.

The processor 1001, for example, controls the entire computer by operating an operating system. The processor 1001 may be composed of a central processing unit (CPU) including an interface with a peripheral device, a control device, an arithmetic device, a register, and the like. For example, the acquisition unit 11, the specifying unit 12, the determination unit 13, the output unit 14, and the like described above may be attained by the processor 1001.

In addition, the processor 1001 reads out a program (a program code), a software module, data, and the like from at least one of the storage 1003 and the communication device 1004 to the memory 1002, and executes various pieces of processing in accordance with the program and the like. As the program, a program for causing a computer to execute at least a part of the operation described in the above embodiment is used. For example, the acquisition unit 11, the specifying unit 12, the determination unit 13, and the output unit 14 may be attained by a control program that is stored in the memory 1002 and operated in the processor 1001, and the other function blocks may be similarly attained. It has been described that the various pieces of processing described above are executed by one processor 1001, but the various pieces of processing may be simultaneously or sequentially executed by two or more processors 1001. The processor 1001 may be implemented by one or more chips. Note that the program may be transmitted from a network via an electric communication line.

The memory 1002 is a computer-readable recording medium, and for example, may be composed of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), and the like. The memory 1002 may store a program (a program code), a software module, and the like that can be executed to carry out a wireless communication method according to one embodiment of the present disclosure.

The storage 1003 is a computer-readable recording medium, and for example, may be composed of at least one of an optical disk such as a compact disc ROM (CD-ROM), a hard disk drive, a flexible disk, a magnetooptic disk (for example, a compact disk, a digital versatile disk, and a Blu-ray (Registered Trademark) disk), a smart card, a flash memory (for example, a card, a stick, and a key drive), a floppy (Registered Trademark) disk, a magnetic strip, and the like. The storage 1003 may be referred to as an auxiliary storage device. The storage medium described above, for example, may be a database, a server, and other suitable media including at least one of the memory 1002 and the storage 1003.

The communication device 1004 is hardware (a transmitting and receiving device) for performing communication with respect to a computer via at least one of a wired network and a wireless network, and for example, is also referred as a network device, a network controller, a network card, a communication module, and the like. The communication device 1004, for example, may be configured by including a high-frequency switch, a duplexer, a filter, a frequency synthesizer, and the like in order to attain at least one of frequency division duplex (FDD) and time division duplex (TDD). For example, the acquisition unit 11, the specifying unit 12, the determination unit 13, the output unit 14, and the like described above may be attained by the communication device 1004.

The input device 1005 is an input device (for example, a keyboard, a mouse, a microphone, a switch, a button, a sensor, and the like) receiving input from the outside. The output device 1006 is an output device (for example, a display, a speaker, an LED lamp, and the like) carrying out output to the outside. Note that the input device 1005 and the output device 1006 may have an integrated configuration (for example, a touch panel).

In addition, each of the devices such as the processor 1001 and the memory 1002 is connected by the bus 1007 for performing the communication of the information. The bus 1007 may be configured by using a single bus, or may be configured by using different buses for each of the devices.

In addition, the store determination device 1 may be configured by including hardware such as a microprocessor, a digital signal processor (DSP), an application specific integrated circuit (ASIC), a programmable logic device (PLD), and a field programmable gate array (FPGA), and a part or all of each of the function blocks may be attained by the hardware. For example, the processor 1001 may be implemented by using at least one of the hardware.

The notifying of the information is not limited to the aspects/embodiments described in the present disclosure, and may be performed by using other methods.

Each of the aspects/embodiments described in the present disclosure may be applied to at least one of a system using long term evolution (LTE), LTE-advanced (LTE-A), SUPER 3G, IMT-advanced, a 4th generation (4G) mobile communication system, a 5th generation (5G) mobile communication system, future radio access (FRA), new radio (NR), W-CDMA (Registered Trademark), GSM (Registered Trademark), CDMA2000, an ultra mobile broadband (UMB), IEEE 802.11 (Wi-Fi (Registered Trademark)), IEEE 802.16 (WiMAX (Registered Trademark)), IEEE 802.20, an ultra-wideband (UWB), Bluetooth (Registered Trademark), and other suitable systems, and a next generation system extended based thereon. In addition, a plurality of systems may be applied in combination (for example, a combination between at least one of LTE and LTE-A and 5G, or the like)

The order of the processing procedure, the sequence, the flowchart, and the like of each of the aspects/embodiments described in the present disclosure may be changed unless there is contradiction. For example, in the method described in the present disclosure, the elements of various steps are presented by using an exemplary order, but the present disclosure is not limited to the presented specific order.

The input and output information or the like may be stored in a specific place (for example, a memory), or may be managed by using a management table. The input and output information or the like can be overwritten, updated, or edited. The output information or the like may be deleted. The input information or the like may be transmitted to other devices.

The determining may be performed by a value represented by 1 bit (0 or 1), may be performed by a truth value (Boolean: true or false), or may be performed by comparing numerical values (for example, comparing with a predetermined value).

Each of the aspects/embodiments described in the present disclosure may be used alone, may be used in combination, or may be used by being switched in accordance with the execution. In addition, the notifying of predetermined information (for example, the notifying of “X”) is not limited to being performed explicitly, but may be performed implicitly (for example, by not performing the notifying of the predetermined information).

The present disclosure has been described in detail, but it is obvious to a person skilled in the art that the present disclosure is not limited to the embodiment described in the present disclosure. The present disclosure can be carried out as modifications and variations without departing from the spirit and the scope of the present disclosure defined by the claims. Therefore, the description of the present disclosure is for illustrative purpose and is not intended to have any restrictive meaning on the present disclosure.

The software should be broadly construed to indicate an instruction, an instruction set, a code, a code segment, a program code, a program, a sub-program, a software module, an application, a software application, a software package, a routine, a sub-routine, an object, an executable file, an execution thread, a procedure, a function, and the like, regardless of being referred to as software, firmware, middleware, a microcode, and a hardware description language, or referred to as other names.

In addition, the software, the instruction, the information, and the like may be transmitted and received via a transmission medium. For example, in a case where the software is transmitted from a website, a server, or other remote sources by using at least one of a wired technology (a coaxial cable, an optical fiber cable, a twisted pair, a digital subscriber line (DSL), and the like) and a wireless technology (an infrared ray, a microwave, and the like), at least one of the wired technology and the wireless technology is included in the definition of the transmission medium.

The information, the signal, and the like described in the present disclosure may be represented by using any of various different technologies. For example, data, an instruction, a command, information, a signal, a bit, a symbol, a chip, and the like that can be mentioned over the entire description may be represented by a voltage, a current, an electromagnetic wave, a magnetic field or magnetic particles, an optical field or a photon, or any combination thereof.

Note that terms described in the present disclosure and terms required to understand the present disclosure may be replaced with terms having the same or similar meanings.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information.

The names used for the parameters described above are not a limited name in any respect. Further, a mathematical formula or the like using such parameters may be different from that explicitly disclosed in the present disclosure.

The term “determining” used in the present disclosure may include various operations. “Determining”, for example, may include considering judging, calculating, computing, processing, deriving, investigating, search (looking up or inquiry) (for example, search in a table, a database, or another data structure), and ascertaining as “determining”. In addition, “determining” may include considering receiving (for example, receiving information), transmitting (for example, transmitting information), input, output, and accessing (for example, accessing data in a memory) as “determining”. In addition, “determining” may include considering resolving, selecting, choosing, establishing, comparing, and the like as “determining”. That is, “determining” may include “determining” any operation. In addition, “determining” may be replaced with “assuming”, “expecting”, “considering”, and the like.

The terms “connected” and “coupled”, or any variations thereof indicate any direct or indirect connection or coupling between two or more elements, and may include one or more intermediate elements between two elements “connected” or “coupled” to each other. The elements may be coupled or connected to each other physically, logically, or in combination thereof. For example, “connecting” may be replaced with “accessing”. In a case where the terms are used in the present disclosure, it can be considered that two elements are “connected” or “coupled” to each other by using at least one of one or more electric wires, cables, and printed electric connections, and as several non-determinative and non-inclusive examples, by using electromagnetic energy or the like having a wavelength in a wireless frequency region, a microwave region, and a light (both of visible and non-visible) region.

The expression “on the basis of” used in the present disclosure does not indicate “only on the basis of” unless explicitly stated otherwise. In other words, the expression “on the basis of” indicates both of “only on the basis of” and “at least on the basis of”.

Any reference to the elements using the addresses “first”, “second”, and the like used in the present disclosure does not generally limit the amount or the order of the elements. Such addresses can be used in the present disclosure as a convenient method for distinguishing two or more elements. Therefore, the reference to the first and second elements does not indicate that only two elements can be adopted or the first element necessarily precedes the second element in any way.

The “means” in the configuration of each of the devices described above may be replaced with a “unit”, a “circuit”, a “device”, and the like.

In the present disclosure, in a case where “include”, “including”, and variations thereof are used, such terms are intended to be inclusive as with the term “comprising”. Further, the term “or” used in the present disclosure is intended not to be exclusive OR.

In the present disclosure, for example, in a case where articles are added by translation, such as a, an, and the in English, the present disclosure may include that the nouns following such articles are in a plural form.

In the present disclosure, the term “A and B are different” may indicate that “A and B are different from each other”. Note that, the term may indicate that “each of A and B is different from C”. The terms “separated”, “coupled”, and the like may be construed as with “different”.

### REFERENCE SIGNS LIST

1 . . . store determination device, 2 . . . mobile terminal, 3 . . . store determination system, 10 . . . storage unit, 11 . . . acquisition unit, 12 . . . specifying unit, 13 . . . determination unit, 14 . . . output unit, 1001 . . . processor, 1002 . . . memory, 1003 . . . storage, 1004 . . . communication device, 1005 . . . input device, 1006 . . . output device, 1007 . . . bus, T . . . target user, U1, U2, U3, U4, U5, U6, U10, U11, U12, U13, U14, U15, U16, U17 . . . user.

1. A store determination device, comprising processing circuitry configured to:
specify a store that each user adjacent to a target user is visiting or is likely to visit; and
determine a store that the target user is visiting, on the basis of the specifying.

2. The store determination device according to claim 1,
wherein the processing circuitry is configured to set a user carrying a mobile terminal adjacent to a mobile terminal carried by the target user as the user adjacent to the target user.

3. The store determination device according to claim 1,
wherein the processing circuitry is further configured to store store information relevant to the store that each user is visiting or is likely to visit,
wherein the processing circuitry is configured to perform specifying with reference to the stored store information.

4. The store determination device according to claim 1,
wherein the processing circuitry is configured to perform specifying by associating an adjacent user who is each user adjacent to the target user with a visit store that is a store that the adjacent user is visiting or is likely to visit.

5. The store determination device according to claim 4,
wherein the processing circuitry is configured to determine the store that the target user is visiting, on the basis of the number of adjacent users associated with each visit store.

6. The store determination device according to claim 4,
wherein the processing circuitry is configured to determine the store that the target user is visiting, on the basis of the number of adjacent users associated with the visit store and the number of users who are visiting or are likely to visit the visit store, for each visit store.

7. The store determination device according to claim 4,
wherein the processing circuitry is configured to determine the store that the target user is visiting, on the basis of a ratio between the number of adjacent users associated with the visit store and the number of users who are visiting or are likely to visit the visit store, for each visit store.

8. The store determination device according to claim 4,
wherein the processing circuitry is configured to determine the store that the target user is visiting, on the basis of the number of users who are visiting or are likely to visit each visit store associated with one or more adjacent users.

9. The store determination device according to claim 4,
wherein the processing circuitry is configured to, on the basis of
the number of adjacent users associated with the visit store, and
the number of adjacencies of the adjacent user to a user who is adjacent to the adjacent user and is visiting or is likely to visit the visit store, for each visit store,
determine the store that the target user is visiting.

10. The store determination device according to claim 4,
wherein the processing circuitry is configured to, on the basis of a number weighted by each of
the number of adjacent users associated with the visit store, and
the number of adjacencies of the adjacent user to a user who is adjacent to the adjacent user and is visiting or is likely to visit the visit store, for each visit store,
determine the store that the target user is visiting.
